(19) United States
(12) Patent Application Publication
(10) Pub. No.: US 2005/0091598 A1
(43) Pub. Date: Apr. 28, 2005

(54) Attaching multiple audio narrations to a single electronic graphical object

(76) Inventors: Robert J. Schmonsees, Potomac, MD (US); James E. Burns, Wayland, MA (US)

Correspondence Address: DAVIDSON BERQUIST JACKSON & GOWDEY LLP, 4501 NORTH FAIRFAX DRIVE, SUITE 920, ARLINGTON, VA, 22203, US

(21) Appl. No.: 10/691,208

(22) Filed: Oct. 23, 2003

(51) Int. Cl. G06F 17/24

(52) U.S. Cl. 715/732; 715/730; 715/731; 715/723; 715/512

(57) ABSTRACT

An electronic application for adding multiple logical narrations to a single Electronic Graphical Object is described in which a creator of the Electronic Graphical Object may add both a Public Narration for general audiences and a Private Narration for selected individuals to provide training or additional secure information on the Electronic Graphical Object. The system allows both the creation of the logically different narrations and the control of who can play either of the narrations.

### FIELD OF THE INVENTION

The present invention relates to computer applications, and more particularly to audio narrations for computer-readable presentations.

### BACKGROUND AND SUMMARY OF THE INVENTION

The present invention relates to a method for attaching multiple and logically different electronic audio narrations to a single Electronic Graphical Object. The Electronic Graphical Object may be, for example, a slide created in Microsoft™ PowerPoint™, or a graphically oriented object like a web page or other electronic document which may, or may not, include some text. The present invention enables the creation of either, or both, or a Public Narration capability for an audience, as well as a Private Narration capability for providing training assistance, coaching, and other information to a person who has to present and explain the Electronic Graphical Object to an audience.

The present invention addresses the problems associated with providing training to employees of an organization on how best to present information contained in electronic presentations and graphics contained on web pages and other electronically stored documents to an audience. An example application may occur when sales and sales support people present information to prospects and customers about the organization's products and services, but also has application whenever anyone makes a presentation to an audience using an Electronic Graphical Object. Currently, the software systems that are used to create electronic presentations, documents, and web pages only come with the ability to attach a single electronic audio narration to an individual slide or other such graphically oriented object. This single narration capability has been primarily designed to be used for public consumption, and to be played with the graphical object when the graphical object is presented to an audience. This single narration could conceivably be used for private training and coaching purposes by dramatically lowering volume, adding a headset, etc. for use in instructing a person presenting the graphical object to others on what to say and how to say it. However, the narration would then occur to the exclusion of simultaneous public audio and would cause concern because the limited security functions would not protect it from being accidentally played to the audience. As such, the single narration feature is rarely, if ever, used for private consumption during a public performance.

If the creator of an Electronic Graphical Object, however, wants to provide Public Narration simultaneously with training and coaching to the presenter, the only way for them to do that with current methods is to add textual notes to the individual slides. This is cumbersome for the creator, and often the presenter does not read these notes during the presentation. Even when these notes are read, they are often cryptic, and as such, may not be understood as well as if the slide creator actually explained how to present the slide in their own voice. Finally these notes are an integral part of the slide creation software architecture and while they can be hidden, there is little in the way of formal security controls to prohibit their exposure when a slide is emailed to the audience.

The present invention provides a method for attaching both a Public Narration and a Private Narration to a single Electronic Graphical Object. The public narration provides audio data that is publicly presented to the audience while the presentation is occurring. The Private Narrator can, when enabled, provide simultaneous and secure training, coaching, and additional information uniquely to the presenter (or other closed group) without being heard by the audience. Alternatively, the Private Narration may be selectively presented in whole or part with the Public Narrator to the audience. The Electronic Graphical Object can be shown with the Public Narration enabled, Private Narrations enabled, with both enabled, or with neither enabled.

The preferred embodiment of the invention uses the Internet as the environment to attach and present individual Electronic Graphical Objects with multiple audio narrations. The invention, however, is not restricted to this embodiment, but may also be accomplished by creation and display methods that are performed through a plug-in or included as functions within local versions of the software that is used to create the Electronic Graphical Object itself.

### BRIEF DESCRIPTION OF THE DRAWINGS

These and other objects, features, and advantages of the present invention will now be described in conjunction with the drawings in which:

FIG. 1 is a general schematic of the present invention allowing multiple narrations to be created and presented in an environment that provides security that protects accidental disclosure of the private narration;

FIG. 2 is a schematic diagram of an example of the current embodiment of the present invention using the Internet; and

FIG. 3 is an example embodiment of a secure web page for a creator/presenter showing an Electronic Graphical Object with multiple narration capability and the ability for a creator/presenter to record and play either or both public and Private Narrations in accordance with one example embodiment of the present invention; and

FIG. 4 is an example embodiment of a web page for an audience showing an Electronic Graphical Object with multiple narration capability, but restricting the ability to play only the Public Narration in accordance with one example embodiment of the present invention.

### DETAILED DESCRIPTION OF THE PRESENTLY PREFERRED EMBODIMENT

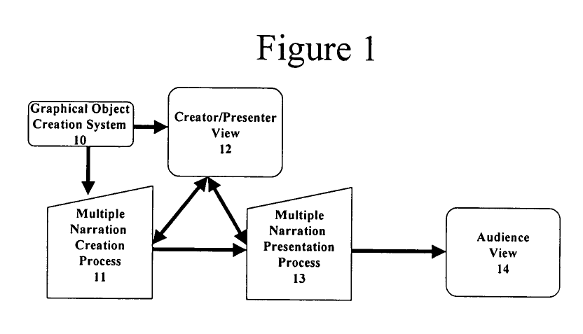

FIG. 1 illustrates an example embodiment of a generalized method for adding multiple audio narrations to a single Electronic Graphical Object and presenting that object in a secure fashion. Electronic Graphical Objects are created by a creator using a commercially available Graphical Object Creation System 10 (for example PowerPoint™ or other graphical application) which interfaces with or includes a Multiple Narration Creation Process 11 that is accessed through a secure Creator/Presenter View 12 that enables the creator of the Electronic Graphical Object to add, at their option, either a Public Narration and or a secure Private Narration to an Electronic Graphical Object. The process allows multiple narrations to be created independently, and it manages each narration as a distinct logical and physical entity with the appropriate identification so that both the creator and eventual presenter are informed of the status of each narration.

A detailed description of the mechanics of adding audio to an Electronic Graphical Object will not be described herein, as such audio additions are already currently available to add a single narration to a Graphical Object. The present invention can employ the known methods of adding a simple narration to add to second narration described herein.

As shown in FIG. 1, the Multiple Narration Creation Process 11 is also linked to a Multiple Narration Presentation Process 13 which enables the creator/presenter to operate in a secure Creator/Presenter View 12, in which they have the option to play either the Public or Private Narration through a secure process that enables the creator/presenter of the Electronic Graphical Object to restrict or hide the playing of the Private Narration. A second Audience View 14 is also available where only the Public Narration is accessible and can be played by anyone who has the ability to display the Electronic Graphical Object.

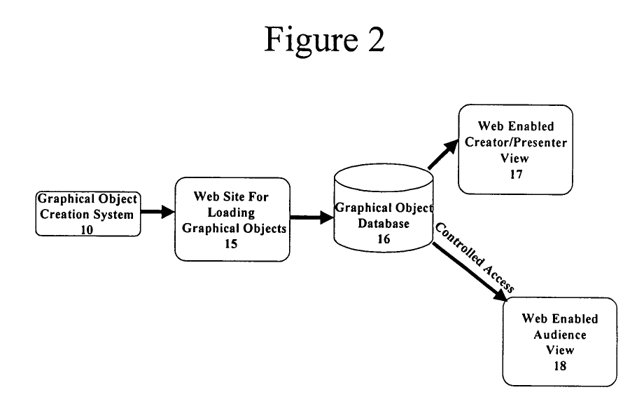

FIG. 2 illustrates an example embodiment of an Internet-enabled method for adding multiple audio narrations to a single Electronic Graphical Object and presenting that object in a secure fashion. A Web Site For Loading Graphical Objects 15 is employed to upload individual objects or entire electronic presentations from the Graphical Object Creation System 10 into a secure Graphical Object Database 16 on a server where each object is managed as an individual data object. Further, all communications that occur between the Graphical Object Creation System 10, the Web Site For Loading Graphical Objects 15, and the Graphical Object Database 16 are not illustrated in FIG. 1, but only those signals which are particularly pertinent to understanding the present invention are provided. The artisan will understand that many other kinds of signals are passed bi-directionally between the Graphical Object Creation System 10, the Web Site For Loading Graphical Objects 15, and the Graphical Object Database 16.

Once an Electronic Graphical Object has been uploaded into the Graphical Object Database 16, an authorized person may create single or multiple narrations for an object by assessing the Graphical Object Database 16, and selecting an individual Electronic Graphical Object, which is then presented to them in the Web-Enabled Creator/Presenter View 17. As FIG. 2 shows there is also the ability for the audience to gain access to the Electronic Graphical Objects in a controlled fashion through the Web Enabled Audience View 18.

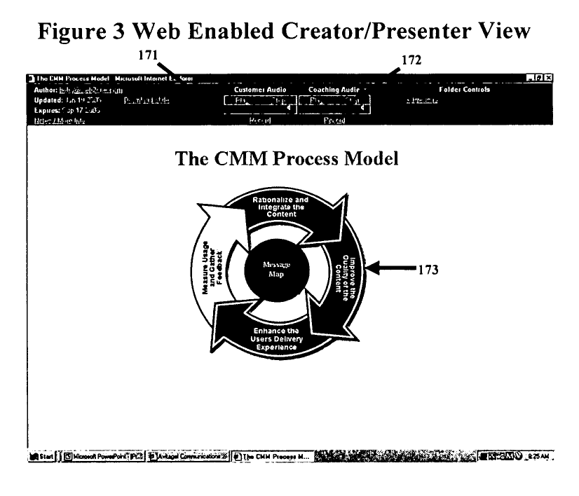

FIG. 3 illustrates an example embodiment of a web page containing an Electronic Graphical Object 173 (in this case, a PowerPoint slide) that is displayed in the Web-Enabled Creator/Presenter View 17. The page includes facilities for both recording (through the Multiple Narration Creation Process 11) and playing (through the Multiple Narration Presentation Process 13) the Public Narration 171 (called Customer Audio in this example embodiment) as well as recording and playing the Private Narration 172 (called Coaching Audio in this example embodiment). As discussed above, when the slide is being presented, the presenter can play the customer audio, which describes the slides for the audience's consumption. Meanwhile, the presenter can also play the coaching audio, which privately gives training and coaching instruction to the presenter regarding the current slide or related topics. Thus, as just one example, the slide could display a product for sale, the Public Audio (customer audio) provide a description of the product for the audience to hear while the slide is displayed, and the Private Audio (coaching audio) provide instructions to the presenter on how to introduce complimentary products or other related topics. In other words, the presenter gets privately coached while the audience receives the slide and Public Audio.

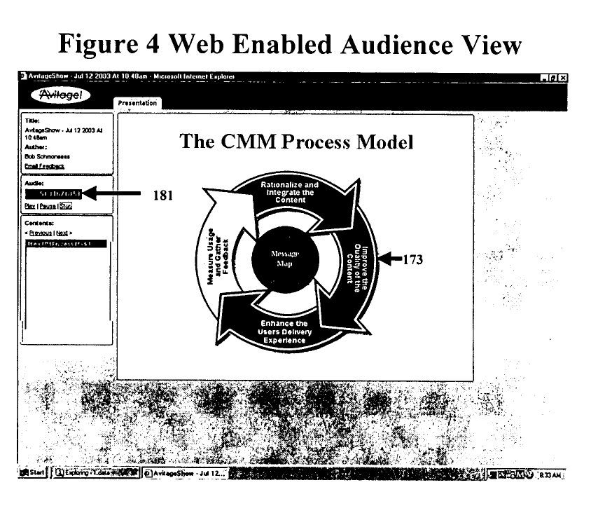

FIG. 4 illustrates an example embodiment of a web page containing the same Electronic Graphical Object 173 that is shown in FIG. 4. However in FIG. 4 this same Electronic Graphical Object is displayed in the Web Enabled Audience View 18, which only has the facilities to view the Electronic Graphical Object and play the Public Narration 181 (called Audio in this example embodiment)

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A presentation slide recorded onto a computer readable medium, comprising:
a graphical object; and
two logically different narrations associated with the graphical object.

2. A presentation according to claim 1, wherein:
one of the logically different narrations provides a public narration for the graphical object to be provided to a presentation audience, and the other of the logically different narrations provides a private narration for the graphical object to be provided to a presenter of the graphical object and not to the presentation audience.

3. A presentation according to claim 1, wherein:
one but not the other of the logically different narrations is playable by any user of the presentation, and the other of the logically different narrations is security protected from disclosure by unauthorized users of the presentations.

4. A system, comprising:
a graphical object creation system to facilitate the creation of a graphical object to be displayed to an audience;
a narration creation facility communicative with the graphical object creation system to associate two independent audio objects with the graphical object; and
a presentation facility to present the graphical object to the audience and one but not the other of the independent audio objects to the audience.

5. A system according to claim 4, wherein:
the presentation facility includes a user selection button to enable said one of the independent audio objects.

6. A system according to claim 4, wherein:
the presentation facility presents the other of the independent audio objects privately to a presenter of the graphical object.

7. A method of presenting a graphical object by a presenter to an audience, comprising:
adding two logically different narrations to a single graphical object;
displaying the graphical object;
simultaneously with the display of the graphical object, playing a first of the narrations to the audience; and
simultaneously with the display of the graphical object, playing a second of the narrations only to the presenter.
